(19) United States
(12) Patent Application Publication
(10) Pub. No.: US 2018/0238511 A1
(43) Pub. Date: Aug. 23, 2018

(54) VEHICLE HEADLIGHT AND METHOD THEREOF

(71) Applicant: OSRAM GmbH, Munich (DE)

(72) Inventors: Andreas Hartmann, Ulm (DE); Thomas Feil, lggingen (DE)

(21) Appl. No.: 15/880,570

(22) Filed: Jan. 26, 2018

(30) Foreign Application Priority Data
Feb. 17, 2017 (DE) 10 2017 103 320.3

(51) Int. Cl. F21S 41/265; F21S 41/663

(52) U.S. Cl. CPC F21S 41/265; F21S 41/151; F21S 41/663

(57) ABSTRACT

A vehicle headlight may include a plurality of selectively activatable light sources configured to emit laterally disjoint light beams, and a lens disposed optically downstream of the light sources and having a light entrance surface and a light exit surface for the light beams. The lens may include a first partial region having a first partial surface of the light entrance surface and a first partial surface of the light exit surface. The lens may further include a second partial region having a second partial surface of the light entrance surface and a second partial surface of the light exit surface. The first partial surface of at least one of the light entrance surface or the light exit surface may have a shape such that the first partial region has a greater divergent effect on light passing through the first partial region than through the second partial region.

### CROSS-REFERENCE TO RELATED APPLICATION

This application claims priority to German Patent Application Serial No. 10 2017 103 320.3, which was filed Feb. 17, 2017, and is incorporated herein by reference in its entirety and for all purposes.

### TECHNICAL FIELD

Various embodiments relate generally to a vehicle headlight, including a plurality of selectively activatable light sources for emitting laterally disjoint light beams, and a lens disposed optically downstream of the light sources and having a light entrance surface and a light exit surface for the light beams, in which the lens includes a first partial region having a first partial surface of the light entrance surface and a first partial surface of the light exit surface, and further includes a second partial region having a second partial surface of the light entrance surface and a second partial surface of the light exit surface. Various embodiments also relate to a vehicle including at least one such vehicle headlight. Various embodiments additionally relate to a method for operating such a vehicle headlight. Various embodiments are applicable e.g. to headlights for motor vehicles, e.g. for generating at least one high beam and/or one low beam.

### BACKGROUND

Automotive headlights including light emitting diodes (LEDs) arranged alongside one another in a matrixlike fashion have the problem of homogeneously linking a partial region of a light emission pattern, said partial region being generated by some of the LEDs, to a partial region generated by other LEDs, particularly if the intention is to utilize the possibility of masking out or switching in sharply delimited partial regions of the light emission pattern.

### SUMMARY

A vehicle headlight may include a plurality of selectively activatable light sources configured to emit laterally disjoint light beams, and a lens disposed optically downstream of the light sources and having a light entrance surface and a light exit surface for the light beams. The lens may include a first partial region having a first partial surface of the light entrance surface and a first partial surface of the light exit surface. The lens may further include a second partial region having a second partial surface of the light entrance surface and a second partial surface of the light exit surface. The first partial surface of at least one of the light entrance surface or the light exit surface may have a shape such that the first partial region has a greater divergent effect on light passing through the first partial region than through the second partial region.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments of the present disclosure are described with reference to the following drawings, in which:

FIG. 1 shows, as a sectional illustration in side view, a schematic diagram of a headlight including a faceted lens in accordance with a first embodiment;

FIG. 2 shows a plan view of the faceted lens from FIG. 1;

FIG. 3 shows an oblique view of the faceted lens;

FIG. 4 shows, as a sectional illustration in side view, a schematic diagram of a headlight including a faceted lens in accordance with a second embodiment;

FIG. 5 shows an image of a light beam after passing through the faceted lens from FIG. 1 or FIG. 4;

FIG. 6 shows an image of a light beam after passing through a different lens; and

FIG. 7 shows the headlight in accordance with the first embodiment in one variant.

### DESCRIPTION

The following detailed description refers to the accompanying drawings that show, by way of illustration, specific details and embodiments in which various aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

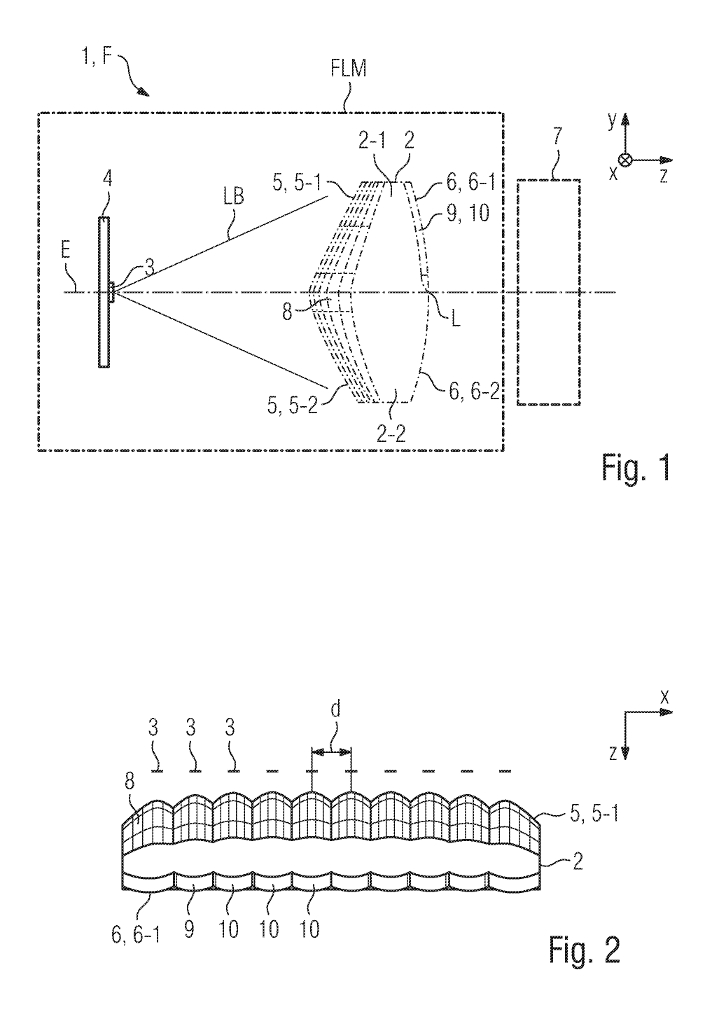

FIG. 1 shows, as a sectional illustration in side view, a schematic diagram of a headlight in the form of a vehicle headlight 1 of a vehicle F including a faceted lens 2 and also including a plurality of LED chips 3 that emit white light according to the ECE. The LED chips 3 are e.g. individually drivable.

The LED chips 3 are arranged here on a common submount 4, e.g. in a (10×1) matrix arrangement or in one series including ten LED chips 3. The LED chips 3 are selectively individually drivable, e.g. switchable on and off and possibly dimmable, and radiate their light beams LB in a z-direction, depicted horizontally here, onto a light entrance surface 5 of the lens 2, e.g. over the whole area as shown. The light beams LB pass through the lens 2 and emerge again at the light exit surface 6 thereof. They are then coupled out of the vehicle headlight 1, specifically directly or by means of an optional coupling-out optical unit 7.

The lens 2 can be subdivided conceptually on a horizontal plane E (i.e. along a plane spanned in the x- and z-directions) into two partial regions namely here into an upper first partial region 2-1 and a lower second partial region 2-2. A first partial surface 5-1 of the light entrance surface 5 and a first partial surface 6-1 of the light exit surface 6 are assigned to the upper partial region 2-1. Analogously, a second partial surface 5-2 of the light entrance surface 5 and a second partial surface 6-2 of the light exit surface 6 are assigned to the lower partial region 2-2. Consequently, the first partial surface 6-1 is separated from the second partial surface 6-2 by a line L which runs in the plane E and is straight when viewed along the z-direction.

The light exit surface 6 is shaped such that the first partial surface 6-1 of the light exit surface 6 has a more strongly divergent effect on the light beams LB in the x-direction than the second partial surface 6-2 of the light exit surface 6. Thus, the first partial region 2-1 also has a more strongly divergent effect than the second partial region 2-2 of the lens 2.

The light entrance surface 5 is provided in its entirety with a faceting 8, which, however, is shaped identically for the associated partial surfaces 5-1 and 5-2 (e.g. is configured mirror-symmetrically with respect to the plane E) and therefore does not bring about a different divergence effect of the partial surfaces 5-1 and 5-2. By contrast, the light exit surface 6 is provided with a faceting 9 only at the first partial surface 6-1, while the second partial surface 6-2 is non-faceted, namely smooth. By means of the faceting 9, the light beams LB are widened in the x-direction.

The components (if appropriate apart from the coupling-out optical unit 7) shown in FIG. 1 can be present as a module, e.g. as a high beam module FLM only for generating a high beam.

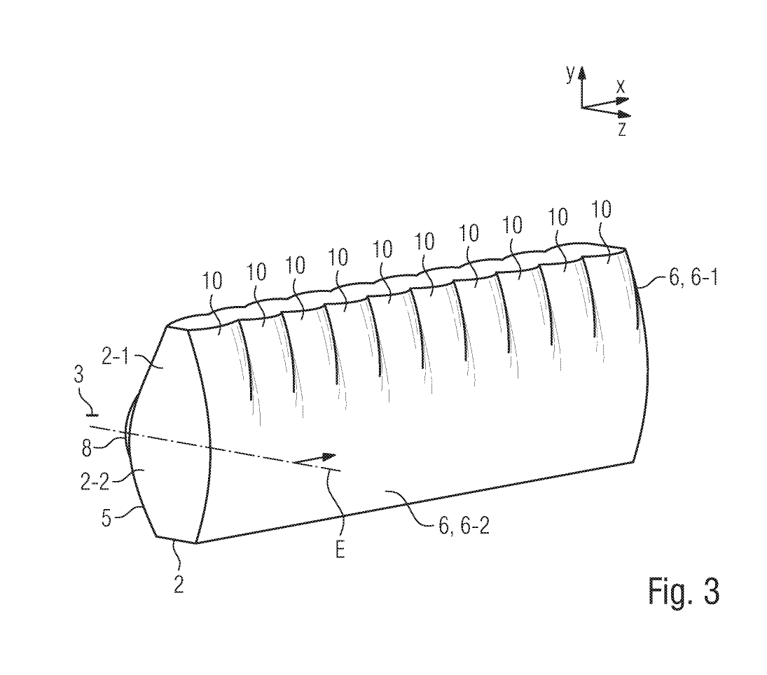

As also shown in FIG. 2 and in FIG. 3, the lens 2 has a basic shape that is profilelike along the x-direction and biconvex in cross section. The faceting 9 of the first partial surface 6-1 is configured as a series of pad-shaped facets 10 extending in a longitudinal extent of the lens 2 (corresponding approximately to the x-direction). The surfaces of the facets 10 have an e.g. sinusoidal or pad-shaped course in the direction of extent of the lens 2. Adjacent facets 10 directly adjoin one another, wherein their notchlike transitions are aligned perpendicularly to the longitudinal extent of the lens 2. Along the y-direction or as viewed from the bottom to the top, a course of the surfaces of the facets 10 at least approximately corresponds to the non-faceted course. The facets 10 thus bring about the widening of a light beam LB passing through them practically only in the x-direction (in both directions).

The facets 10 have the same pitch d. The pitch d corresponds to the pitch of the LED chips 3 in the x-direction. Moreover, the LED chips 3 are arranged rectilinearly behind respectively assigned facets 10 in the x-direction. A main emission direction of the LED chips 3 along the z-direction thus runs centrally through the respectively assigned facet 10. What can thus be brought about, in particular, is that a light beam LB emitted by a specific LED chip 3 emerges from the lens 2 substantially only through the respectively assigned facet 10. The facets 10 can have an identical or a different curvature.

The light beams LB of the LED chips 3 are situated in cross section partly above the plane E and partly below the plane E. They thus pass partly through the first partial region 2-1 and partly through the second partial region 2-2. In this case, the beam region passing through the first partial region 2-1 is widened, whereas the beam region passing through the second partial region 2-2 is not widened.

Referring to FIG. 2, a cornering light can be implemented by outer LED chips 3 of the series shown being activated depending on a steering lock of the vehicle F. As a result, a brightness maximum of the light emission pattern generated by coincidence of the individual light beams LB is shifted in the direction of the steering lock, e.g. to a greater extent, the greater the steering lock.

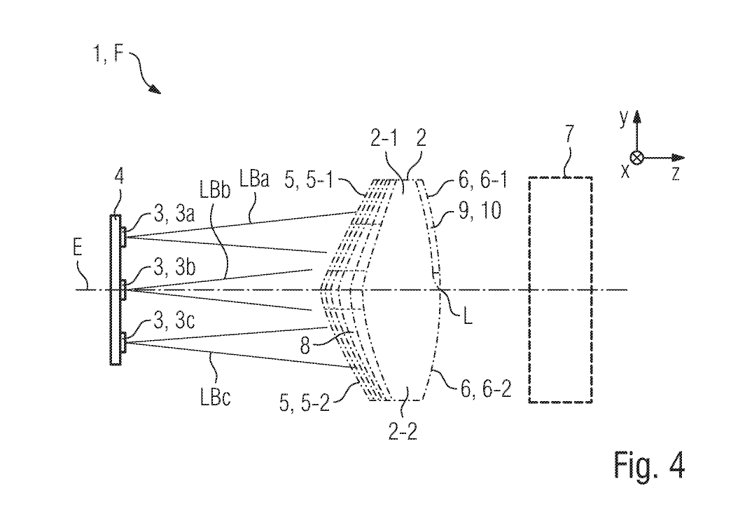

FIG. 4 shows, as a sectional illustration in side view, a schematic diagram of a vehicle headlight 11. The vehicle headlight 11 is constructed similarly to the vehicle headlight 1, but differs in that the LED chips 3 here are arranged in a (10×3) matrix arrangement in three series 3a, 3b, 3c arranged one above another.

The light beams LBa of the LED chips 3 of the upper series 3a pass only through the upper partial region 2-1 of the lens 2, such that they are widened in the x-direction over their entire height (along the y-direction) by means of the facets 10. The light beams LBc of the LED chips 3 of the lower series 3c pass only through the lower partial region 2-2 of the lens 2, such that they are not or not appreciably widened in the x-direction at the second partial surface 6-2.

The light beams LBb of the LED chips 3 of the middle series 3b are situated in cross section partly above the plane E and partly below the plane E. They thus pass partly through the first partial region 2-1 and partly through the second partial region 2-2. In this case, the beam region passing through the first partial region 2-1 is widened, whereas the beam region passing through the second partial region 2-2 is not widened.

In one variant, the light beams LBa, LBb, LBc of all three series 3a, 3b and 3c radiate partly through the first partial region 2-1 and partly through the second partial region 2-2. In various embodiments, the light beams LBa, LBb, LBc can irradiate the light entrance surface 5 of the lens 2 over the whole area.

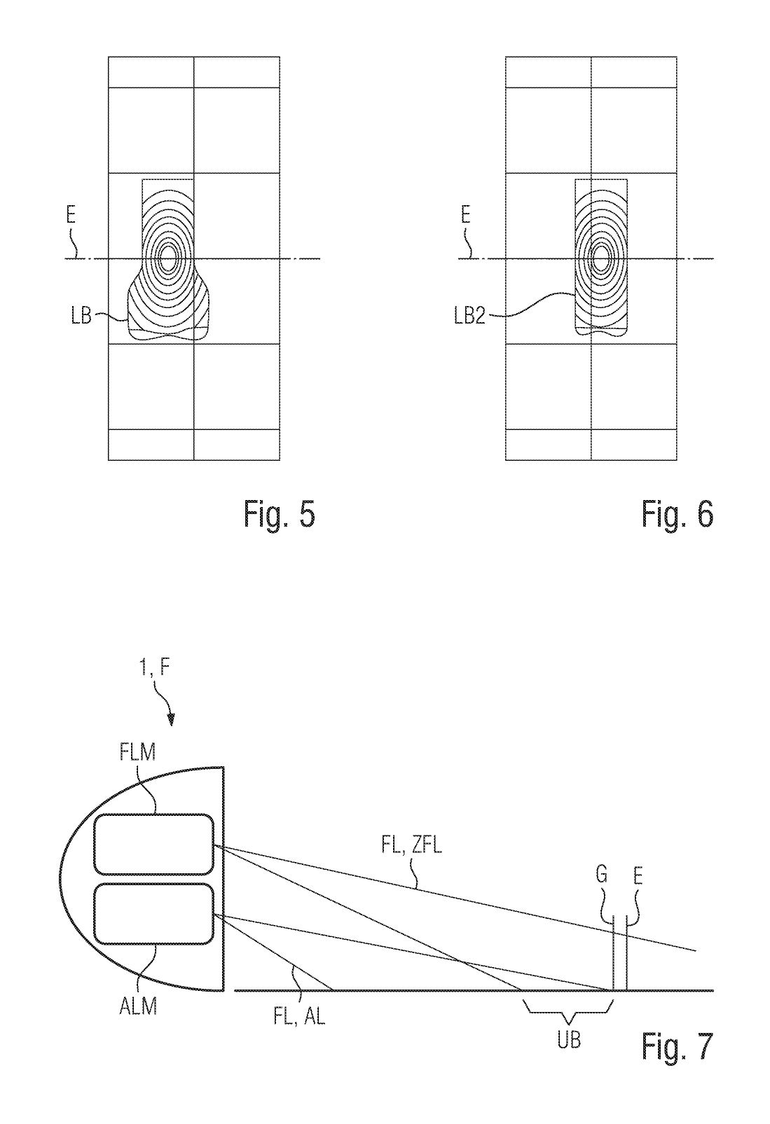

FIG. 5 shows an image in cross section of a brightness distribution of a light beam LB of an LED chip 3 of the middle series after passing through the faceted lens 2 and after coupling out of the vehicle headlight 1.

In this case, an orientation is mirrored horizontally in comparison with FIG. 1, e.g. by means of the coupling-out optical unit 7. Light rays passing through the upper partial region 2-1 of the lens 2 are illustrated here below the plane E, and light rays passing through the lower partial region 2-2 of the lens 2 are illustrated above the plane E. The light beam LB is projected onto the road in the orientation shown. The further down a light spot is in FIG. 4, the closer it is to the vehicle headlight 1.

That part of the light beam LB which passes through the upper partial region 2-1 of the lens 2 is widened. If adjacent light beams (not illustrated) of the LED chips 3 of the middle series are also switched on, the widened partial regions of said light beams LB, said partial regions being illustrated here below the plane E, overlap, as a result of which a brightness distribution made highly uniform horizontally is achieved. By contrast, those partial regions of horizontally adjacent light beams LB which are illustrated above the plane E do not overlap or scarcely overlap.

The brightness distributions of vertically adjacently arranged light beams of different series can be separated from one another, e.g. practically without any gaps, or can overlap (vertically) for a higher uniformity of the combined brightness distribution.

FIG. 6 shows an image of a light beam LB2 after passing through a lens (not illustrated) which is constructed similarly to the lens 2 but has no faceting 9. Here the incident light beams are brought to the upright rectangular shape, but not widened, by the lens. The faceting 8 brings about the rectangular shape of the brightness distribution shown.

Returning again to FIG. 1 to FIG. 4, the light strip generated by the middle series of LED chips 3—said light strip at least approximately corresponding to the line L—can represent a fringe of a light emission pattern generated by the vehicle headlight 1. Said fringe can correspond to a bright/dark boundary of a low beam. The low beam can be generated e.g. by the activation of some or all LED chips 3 of the upper series and of the middle series. A high beam can be generated by switching on the LED chips 3 of the lower series. For example the LED chips 3 of the lower series can be individually dimmed or switched off in order to cut out corresponding partial regions of the light emission pattern, e.g. in order to avoid dazzle for objects identified there. The LED chips 3 of the middle and upper series can also be activatable only jointly in groups.

FIG. 7 shows the headlight 1 in accordance with the first embodiment in one possible variant. The headlight 1 includes at least one low beam module ALM for generating a low beam AL and at least one high beam module FLM for additively generating an additional high beam ZFL. In a low beam operating mode, only the at least one low beam module ALM is in operation and generates the low beam AL. In order to generate a high beam in a high beam operating mode, the high beam module FLM is additionally switched on and generates the additional high beam ZFL. The complete light emission pattern of a high beam FL is a superimposition of the two light patterns AL and ZFL, that is to say FL=AL+ZFL.

In order to maintain a homogeneous brightness impression in the region of the low beam AL, that proportion of the additional high beam ZFL which is radiated into an overlap region UB of low beam AL and additional high beam ZFL corresponds to the widened proportion radiated through the first partial region 2-1 (corresponding to the proportion shown below the plane E as shown in FIG. 5). The transition—taking place in the region of the plane E—to the non-widened proportion of the additional high beam ZFL can at least approximately correspond to a bright/dark boundary G of the low beam AL or, as shown, lie outside the low beam AL.

Although the embodiments have been more specifically illustrated and described in detail by means of the exemplary embodiment shown, nevertheless the present disclosure is not restricted thereto and other variations can be derived therefrom by the person skilled in the art, without departing from thesubject matter herein.

In this regard, it is also possible to provide a plurality of lower and/or upper series of LED chips.

Furthermore, an optical unit for beam shaping and/or beam directing, e.g. at least one primary optical unit, at least one reflector, at least one lens, etc., can generally be present between the light sources and the lens. The at least one reflector can be e.g. a micromirror array. In this case, a light source can also be understood to mean a respective individual micromirror, specifically even if the micromirror array is irradiated by a single light beam of corresponding width.

Generally, “a(n)”, “one”, etc. can be understood to mean a singular or a plural, in particular in the sense of “at least one” or “one or a plurality”, etc., as long as this is not explicitly excluded, e.g. by the expression “exactly one”, etc.

Moreover, a numerical indication can encompass exactly the indicated number and also a customary tolerance range, as long as this is not explicitly excluded.

Various embodiments may overcome the disadvantages of the prior art and provide e.g. an improved possibility for the shape-variable illumination of a spatial region in front of a headlight.

Various embodiments provide a vehicle headlight, including a plurality of selectively activatable light sources for emitting laterally disjoint light beams, and a common lens disposed optically downstream of the light sources and having a light entrance surface and a light exit surface for the light beams. The lens includes a first partial region, which includes a first partial surface of the light entrance surface and an associated first partial surface of the light exit surface, and includes a second partial region, which includes a second partial surface of the light entrance surface and an associated second partial surface of the light exit surface. The first partial surface of the light entrance surface and/or of the light exit surface is shaped such that the first partial region has a more strongly divergent effect on light passing through than the second partial region. This vehicle headlight has the advantage that light beams which pass through the first partial region diverge to a comparatively great extent sideways or laterally and thus overlap one another to a greater extent downstream of the lens. The overlap advantageously brings about an avoidance of appreciable brightness transitions between adjacent light beams and generally an intensified homogenization of that proportion of the light emission pattern which is generated by said light beams. Light beams which pass through the second partial region diverge to a lesser extent, however, such that adjacent light beams overlap only slightly—for example even practically do not appreciably overlap. Therefore, a sharply delimited region can be omitted or masked out more advantageously upon a deactivation of a light source and thus a switch-off of a light beam in the associated light pattern. The lens thus brings about a different beam shaping of the light beams, which beam shaping is usable for different illumination purposes, depending on the partial region through which the associated light beam passes. By virtue of the fact that light beams pass partly through the first partial region and partly through the second partial region, light beams which in one portion appreciably overlap and in another portion overlap little or not at all arise downstream of the lens. Since the more strongly divergent portion and the less divergent portion of a specific light beam merge continuously into one another, a particularly homogeneous linking between them is achieved.

In various embodiments, the vehicle headlight is configured in such a way that, in the switched-on operating state of the vehicle headlight, light from one or more light sources of the vehicle headlight is radiated through both the first partial region and the second partial region of the lens.

“Selectively activatable light sources” can be understood to mean light sources which are activatable individually and/or in groups. Activation and deactivation may include switching on and switching off, respectively, if necessary also dimming of the relevant light source.

In one development, the light sources are semiconductor light sources, e.g. light emitting diodes (LEDs) or diode lasers. If a plurality of semiconductor light sources are present, they can emit light in the same color or in different colors. A color can be monochromic (e.g. red, green, blue, etc.) or multichromic (e.g. white). Moreover, the light emitted by at least one semiconductor light source can be an infrared light (IR-LED) or an ultraviolet light (UV-LED). A plurality of semiconductor light sources can generate a mixed light; e.g. a white mixed light, for example designed in accordance with ECE.

At least one semiconductor light source can contain at least one wavelength-converting phosphor (conversion LED). The phosphor can alternatively or additionally be arranged in a manner remote from the semiconductor light source (“remote phosphor”, LARP arrangement). At least one semiconductor light source can be present in the form of at least one individually packaged semiconductor light source or in the form of at least one chip (die, bare chip). A plurality of chips can be mounted on a common substrate (“submount”). Instead of or in addition to inorganic light emitting diodes, e.g. on the basis of InGaN or AlInGaP, organic LEDs (OLEDs, e.g. polymer OLEDs) are generally usable as well. The at least one semiconductor light source can be equipped with at least one dedicated and/or common optical unit for beam guiding, e.g. at least one Fresnel lens, collimator, and so on.

“Laterally disjoint light beams” can be understood to mean, for example, light beams which do not completely coincide or overlap one another. Two disjoint light beams, in an image plane, can be completely separated from one another or only partly coincide or overlap one another. The partial coincidence of two light beams can be dimensioned e.g. such that they coincide by not more than 25%, e.g. by not more than 20%, e.g. by not more than 15%, e.g. by not more than 10%, e.g. by not more than 5%, of their respective cross-sectional area. The cross-sectional area can be considered e.g. within a contour in which a brightness or a luminous flux of the light is not more than 1/e or 1/e² of a maximum brightness or of a maximum luminous flux.

The first and second partial regions—and thus also the first and second partial surfaces of the light entrance surface and of the light exit surface—e.g. directly adjoin one another.

The fact that the first partial region has a more strongly divergent effect than the second partial region can encompass e.g. the fact that light beams passing through the first partial region, in at least one horizontal spatial direction with respect to the direction of propagation of the respective light beam, are spread to an appreciably greater extent than if they passed through the second partial region.

In one development, light beams passing through the first partial region, in exactly one spatial direction, are spread to an appreciably greater extent than light beams passing through the second partial region.

The fact that light beams (in cross section) pass partly through the first partial region and partly through the second partial region has the effect, for example, that their light distributions overlap appreciably in those regions in which the light passed through the first partial region, and do not overlap appreciably in those regions in which the light passed through the second partial region.

In one development, the first partial surface of the light entrance surface has a more strongly divergent effect than the second partial surface of the light entrance surface. In an alternative or additional development, the first partial surface of the light exit surface has a more strongly divergent effect than the second partial surface of the light exit surface.

In one configuration, that surface of the first partial region which has a more strongly divergent effect (that is to say the first partial surface of the light entrance surface and/or of the light exit surface) is separated from the adjacent surface of the second partial region (i.e. from the second partial surface of the light entrance surface and/or of the light exit surface) by a smooth line, e.g. a straight line. This may afford the effect that it is possible in a simple manner to generate a light emission pattern in which there is a particularly well defined boundary between a particularly homogeneously illuminated partial region and a particularly precisely developing or varying partial region.

In another configuration, the line in a light emission pattern of the vehicle headlight at least approximately corresponds to a bright/dark boundary, e.g. of a low beam. Alternatively, in the case of a transition between the light passing through the first partial region and the light passing through the second partial region, a jump in brightness between different brightness values occurs, but a sharp bright/dark boundary does not occur. In one development, for example, a brightness in the case of a transition between the light passing through the first partial region and the light passing through the second partial region remains practically the same or changes only slightly.

In a further configuration, that surface of the first partial region which has a more strongly divergent effect is a structured, in particular faceted, surface, and the surface of the second partial region is a non-faceted, e.g. non-structured (smooth), surface. In this regard, the different divergence effect can be provided with a particularly low production outlay.

In one development, if the light entrance surface or the light exit surface have a uniformly—possibly even not at all—divergent effect (by virtue of the associated first and second partial surfaces having an identically divergent effect), said surface as a whole is configured such that it is non-faceted or faceted in an identical way.

In one development, the lens has an elongate basic shape. This shape may be provided for generating a light emission pattern that can be illuminated uniformly in this direction.

In yet another configuration, the lens has a profilelike basic shape. This shape may be provided for generating a light emission pattern that can be illuminated uniformly in the width thereof. Such a lens thus has a substantially identical cross-sectional shape along its profile extent (often also referred to as longitudinal extent). The “substantially” identical cross-sectional shape can be in particular a cross-sectional shape which changes only slightly along its profile extent, e.g. on account of a structuring (e.g. faceting) of its light entrance surface and/or light exit surface, but maintains its basic shape.

In one configuration, moreover, the lens has a basically biconvex cross-sectional shape. However, it is not restricted thereto and can for example also have a convexo-concave, biconcave, plano-convex, plano-concave, paraboloidal, freeform, etc., basic shape in cross section.

Furthermore, in one configuration, the faceted surface includes at least one series of facets extending along a longitudinal extent of the lens, which widen the light passing through the first partial region in the direction of the longitudinal extent. Such a construction is producible in an effective and simple manner. Adjacent facets adjoin one another in particular directly. In various embodiments, each facet can be assigned a respective light source whose light beam passes through the first partial region and through the second partial region.

In one development, the faceted surface includes exactly one series of facets extending in a longitudinal extent of the lens. As a result, a light emission pattern made more uniform along the longitudinal extent is generated, but said light emission pattern is not appreciably influenced by the faceting perpendicularly thereto.

In one configuration, moreover, the facets are configured as at least one series of directly adjacent pad-shaped facets whose transitions are aligned e.g. perpendicularly to the longitudinal extent of the lens. The pad-shaped facets are producible in a particularly simple manner. A pad-shaped facet may have e.g. a shape that is curved concavely in the longitudinal extent of the lens, e.g. a sinusoidal or parabolic shape. In the circumferential direction the facet can follow the basic shape of the lens.

The surfaces of the facets can have the same curvature or different curvatures.

Moreover, in one configuration, the facets have an identical spacing or “pitch” with respect to one another.

In another configuration, moreover, the light sources are arranged alongside one another in a matrixlike fashion, e.g. in an (m×n) pattern where m and/or n>1, e.g. in a (5×3), (10×5) etc. pattern. The numbers m and n are not restricted, in principle, and can even be of an order of magnitude of 100, 1000, 10 000 etc. The matrixlike arrangement affords the advantage that the light sources can be arranged with a particularly close spacing with respect to one another, e.g. if the light sources are configured as rectangular LED chips. Said LED chips can be present e.g. on a common substrate (e.g. on a common submount).

In a development which may be provided for generating a particularly homogeneous partial region of the light emission pattern, the pitch of the facets of the lens corresponds to a pitch of the light sources in the same direction, e.g. in the longitudinal extent of the lens.

In another configuration, all light beams pass both through the first partial region and through the second partial region. In this case, the associated light sources can be arranged one above another (e.g. vertically) and/or alongside one another (e.g. horizontally).

In another configuration, moreover, at least one light beam passes only through the first partial region and/or at least one light beam passes only through the second partial region. This enables a particularly flexible choice of a light emission pattern.

Various embodiments provide a lens of the type described above.

Various embodiments provide a vehicle including at least one vehicle headlight as described above, e.g. two vehicle headlights as described above. The vehicle can be configured analogously to the vehicle headlight and affords the same effects.

The vehicle can be a motor vehicle (e.g. an automobile such as a car, truck, bus, etc. or a motorcycle), a train, a watercraft (e.g. a boat or a ship), or an aircraft (e.g. an airplane or a helicopter).

In one development, the vehicle headlight can be designed to emit a high beam. In another development, the vehicle headlight can be designed to optionally emit a low beam and a high beam. In yet another development, the vehicle headlight can be designed to emit a low beam. Alternatively or additionally, the vehicle headlight can be designed to emit an adaptive cornering light. The vehicle headlight can be designed e.g. to emit the low beam and the adaptive cornering light.

In another configuration, the vehicle headlight includes at least one low beam module for generating a low beam and at least one high beam module configured as above for generating an additional high beam. In this regard, the low beam and the high beam can be implemented by means of a single headlight in a particularly easily configurable, compact and inexpensive manner.

In one configuration thereof, the vehicle headlight is designed to generate the low beam in a first operating mode by activating the low beam module, and to generate a high beam in a second operating mode by additionally activating the high beam module, wherein an overlap region of the low beam and the additional high beam includes only that widened proportion of the additional high beam which is radiated through the first partial region. This may afford the effect that the low beam, the brightness of which is typically highly homogeneous, does not appreciably lose homogeneity as a result of the superimposition of the additional high beam.

Various embodiments provide a method for operating the vehicle headlight as described above, wherein at least two light sources are activated simultaneously, the adjacent light beams of which are radiated through the first partial region and through the second partial region.

In one configuration, all light beams of activated light sources are radiated in each case through the first partial region and through the second partial region. This configuration is particularly advantageously usable for generating a high beam or a low beam with a cornering light function.

In another configuration, the vehicle headlight is switched at least between a first operating mode and a second operating mode, wherein in the first operating mode only light sources are activated whose light beams are radiated through the first partial region and through the second partial region and whose light beams are radiated through only one of the partial regions of the lens, and in the second operating mode light sources are additionally activated whose light beams pass only through the other partial region of the lens. This configuration is particularly advantageous for headlights having combined light functions, for example a headlight having a low beam light function and a high beam light function. By way of example, in the first operating mode, a particularly homogeneous light emission pattern of a first light function can be generated, and a second light function can be generated by switching in the light sources in the second operating mode. In the first operating mode, e.g. those light beams which radiate in each case through both partial regions of the lens generate at least one section of an edge or fringe of the light emission pattern in particular a section the furthest away from the headlight.

In one development, a low beam is generated in the first operating mode and a high beam is generated in the second operating mode. This may afford the effect that the low beam generated in the first operating mode is distributed particularly homogeneously and therefore also homogeneously illuminates a region in front of the vehicle. Those light beams which pass in each case through both partial regions of the lens can then form in particular a front fringe of the light emission pattern, which fringe corresponds to a bright/dark boundary in the first operating mode and enables a uniform transition in the second operating mode.

However, it is also possible to operate the headlight in a single operating mode, in which the light beams are operated analogously to the second operating mode described above. In this case, e.g. those light sources whose light beams pass through the second partial region of the lens can be individually activated or deactivated in order to prevent other road users from being dazzled, or the like. Such an operating mode can be e.g. generation of a low beam in which a partial region of the light emission pattern that is closer to the vehicle is formed by those light sources whose light beams at least partly pass through the first partial region of the lens (“basic light”) and a partial region of the light emission pattern that is more distant from the vehicle is formed by those light sources whose light beams pass through the second partial region of the lens (“kink light”).

However, still other light emission patterns or combinations thereof can also be generated by means of the methods described above, for example in order to provide an adaptive cornering light. In this case, during cornering an additional side light can be generated for example by those light sources whose light beams pass through the second partial region of the lens.

In principle, however, the light sources can be activated or deactivated in any desired way.

List of Reference Signs

| | |
|---|---|
| Vehicle headlight | 1 |
| Lens | 2 |
| First partial region of the lens | 2-1 |
| Second partial region of the lens | 2-2 |
| LED Chip | 3 |
| Submount | 4 |
| Light entrance surface | 5 |
| First partial surface of the light entrance surface | 5-1 |
| Second partial surface of the light entrance surface | 5-2 |
| Light exit surface | 6 |
| First partial surface of the light exit surface | 6-1 |
| Second partial surface of the light exit surface | 6-2 |
| Coupling-out optical unit | 7 |
| Faceting of the light entrance surface | 8 |
| Faceting of the light exit surface | 9 |
| Facet | 10 |
| Low beam | AL |
| Low beam module | ALM |
| Pitch | d |
| Plane | E |
| Vehicle | F |
| High beam | FL |
| High beam module | FLM |
| Bright/dark boundary | G |
| Line | L |
| Light beam | LB |
| Light beam | LB2 |
| Overlap region | UB |
| x-direction | x |
| y-direction | y |
| z-direction | z |
| Additional high beam | ZFL |

While various aspects of the present disclosure have been particularly shown and described with reference to specific embodiments, it should be understood by those skilled in the art that various changes in form and detail may be made therein without departing from the spirit and scope of the present disclosure as defined herein. The scope of the various aspects is thus indicated by the present disclosure and all changes which come within the meaning and range of equivalency of the present disclosure are therefore intended to be embraced.

What is claimed is:

1. A vehicle headlight, comprising:
a plurality of selectively activatable light sources configured to emit laterally disjoint light beams; and
a lens disposed optically downstream of the light sources, the lens having a light entrance surface for the light beams and a light exit surface for the light beams;
wherein the lens comprises a first partial region, the first partial region including a first partial surface of the light entrance surface and a first partial surface of the light exit surface,
wherein the lens further comprises a second partial region, the second partial region including a second partial surface of the light entrance surface and a second partial surface of the light exit surface;
wherein the first partial surface of at least one of the light entrance surface or the light exit surface has a shape such that the first partial region has a greater divergent effect on light passing through the first partial region than light passing through the second partial region.

2. The vehicle headlight of claim 1,
wherein one or more of the light sources are configured to radiate light through both the first partial region and the second partial region of the lens in an operational state of the vehicle headlight.

3. The vehicle headlight of claim 1,
wherein the first partial surface of the first partial region, which has the greater divergent effect, is delineated from a surface of the second partial region, which is adjacent thereto, by a smooth line, and
the smooth line, at least approximately, corresponds to a boundary in a light emission pattern of the vehicle headlight.

4. The vehicle headlight of claim 3,
wherein the smooth line is a straight line

5. The vehicle headlight of claim 1,
wherein the first partial surface of the first partial region, which has the greater divergent effect, is a faceted surface and
a surface of the second partial region, which is adjacent thereto, is a non-faceted surface.

6. The vehicle headlight of claim 5,
wherein the faceted surface comprises at least one series of facets extending in a longitudinal extent of the lens, and
the at least one series of facets is configured to widen light beams passing through the first partial region in the longitudinal extent.

7. The vehicle headlight of claim 6,
wherein the at least one series of facets is at least one series of directly adjacent pad-shaped facets having transitions that are aligned perpendicularly to the longitudinal extent of the lens.

8. The vehicle headlight of claim 6,
wherein facets of the at least one series of facets have an identical pitch therebetween.

9. The vehicle headlight of claim 6,
wherein the lens has a biconvex cross-sectional shape.

10. The vehicle headlight of claim 1,
wherein the light sources are arranged alongside one another in an array.

11. The vehicle headlight of claim 1,
wherein each of the light sources is configured to radiate light through both the first partial region and the second partial region of the lens in an operational state of the vehicle headlight.

12. The vehicle headlight of claim 1,
wherein one or more of the light sources are configured to radiate at least one of:
at least one light beam that only passes through the first partial region in an operational state of the vehicle headlight or
at least one light beam that only passes through the second partial region in an operational state of the vehicle headlight.

13. The vehicle headlight of claim 11, further comprising:
at least one low beam module configured to generate a low beam; and
at least one high beam module configured to generate an additional high beam,
wherein the at least one high beam module is further configured to
generate the low beam, in a first operating mode, by activating the at least one low beam module, and
generate a high beam, in a second operating mode, by activating the at least one low beam module in supplement to the at least one high beam module;
wherein an overlap region of the low beam and the additional high beam comprises only a proportion of the additional high beam which is radiated through the first partial region.

14. A method for operating a vehicle headlight including a plurality of selectively activatable light sources and a lens disposed optically downstream of the light sources, the light sources being configured to emit laterally disjoint light beams, the lens having a light entrance surface for the light beams and a light exit surface for the light beams, the lens comprising a first partial region and a second partial region, the first partial region including a first partial surface of the light entrance surface and a first partial surface of the light exit surface, the second partial region including a second partial surface of the light entrance surface and a second partial surface of the light exit surface, the first partial surface of at least one of the light entrance surface or the light exit surface having a shape such that the first partial region has a greater divergent effect on light passing through the first partial region than light passing through the second partial region, the method comprising:
activating at least two light sources of the light sources simultaneously, such that light beams of the at least two light sources pass through the first partial region and through the second partial region.

15. The method of claim 14,
wherein said activating at least two light sources of the light sources simultaneously comprises:
activating the at least two light sources of the light sources simultaneously, such that each light beam of the at least two lights sources is radiated through the first partial region and through the second partial region.

16. The method of claim 14, further comprising:
switching to a first operating mode or a second operating mode;
activating, upon switching to the first operating mode, only one set of light sources among the light sources, such that each light beam of the one set of light sources only pass through one partial region among the first partial region and the second partial region; and
activating, upon switching to the second operating mode, a further set of light sources among the light sources, such that light beams of the further set of light sources only pass through a partial region other than the one partial region,
wherein said activating, upon switching to the second operating mode, a further set of light sources among the light sources comprises:
activating, upon switching to the second operating mode, the further set of light sources in supplement to the one set of light sources.
